(19) United States
(12) Patent Application Publication
(10) Pub. No.: US 2020/0281216 A1
(43) Pub. Date: Sep. 10, 2020

(54) METHOD FOR PRODUCING FAT-BASED SUBSTRATE UTILIZED FOR PREPARING MULTIPLE DESSERT TYPES

(71) Applicant: GARLIC & HERBS DOROT AGRICULTURAL COOPERATION LTD, DOROT (IL)

(72) Inventors: ARTURO GEIFMAN, HOD HASHARON (IL); ORAN KARIV, TEL-AVIV (IL); TAL LEIZER, ZIKHRON YAACOV (IL)

(21) Appl. No.: 16/884,088

(22) Filed: May 27, 2020

Related U.S. Application Data
(63) Continuation of application No. PCT/IL2020/050190, filed on Feb. 20, 2020.
(60) Provisional application No. 62/809,646, filed on Feb. 24, 2019.

(51) Int. Cl. A21D 2/16; A23L 29/20; A23L 29/10; A23L 33/12; A21D 2/18

(52) U.S. Cl. CPC A21D 2/165; A23L 29/20; A23V 2002/00; A23L 33/12; A21D 2/18; A23L 29/10

(57) ABSTRACT

The subject matter discloses an edible composition for preparing multiple edible products, said composition comprising a flavor base, hydrocolloids, edible oil comprising fatty acids and at least two emulsifying agents selected from a group comprising (a) a mixture of diglycerides and monoglycerides of fatty acids, (b) Sucrose esters of fatty acids, (c) Polyglycerol esters of fatty acids (d) Polyglycerol polyricinoleate.

### FIELD OF THE INVENTION

The present invention relates to the field of food product production, in particular a method for producing a fat-based substrate utilized for self-home-made food products.

### BACKGROUND OF THE INVENTION

Food products having a sweet taste, such as deserts, are popular among all ages. The shelves of retail stores are filled with ready-to-eat deserts, such as cakes, creams, chocolate-based deserts and the like. These ready-to-eat deserts are relatively expensive to the end customer while requiring cooling and consume significant shelf space. One of the main competitors to the ready-to-eat deserts is Do-It-Yourself packages including a base for preparing the deserts. One of the world's market leaders in the Do-It-Yourself packages industry is Pillsbury, which sells baking mixtures which need to be mixed with water or other basic ingredients, such as milk or cream, bake in the oven and the desert is ready.

However, these Do-It-Yourself packages are limited to a single food product per package due to the ingredient's composition in the package. For example, the content of the Do-It-Yourself packages for self-home-made chocolate cake are significantly different from the Do-It-Yourself packages used for self-home-made mousse, which are much different from ingredients required for preparing self-home-made muffins etc. These limitations also narrow the number of optional Do-It-Yourself packages one can find on the shelves of the food stores.

### SUMMARY OF THE INVENTION

The present invention discloses a method to produce a vegetable fat-based substrate designed to be utilized as a fundamental material for preparing multiple and diverse self-home-made food products. Such multiple and diverse self-home-made food products can be baking products, dessert products, mousses, and the like. The fat-based substrate produced by the method disclosed herein is characterized by relatively high volume of a flavor base composition, such as chocolate and/or edible oil compounds characterized by melting point which is higher than 40 degrees Celsius, and fatty acids characterized by between 45% and 82% of saturated fatty acids. The fat-based substrate is designed to be utilized as fundamental material for preparing multiple and diverse self-home-made food products, wherein the fat-based substrate may be provided in a frozen or chilled or shelf-stable state. In some cases, the fat-based substrate is provided in a bar-shaped structure packaged in a high-barrier molds, at the weight of essentially 70 grams-200 grams.

The fat-based substrate may comprise a blend of different emulsifiers, vegetable oils and hydrocolloids that enables to create different desserts and bakery products, as opposed to fat-based substrates known in the prior art.

The fat-based substrate can comprise:

A flavor base composite, for example in the flavor of Chocolate, vanilla-based, tahini, caramel, salted caramel, lemon, orange, almonds, nuts, strawberry, maple, dulce de leche, toffee, red velvet and the like. In case the flavor base composite has a chocolate flavor, as elaborated below, the fat-based substrate composite may comprise the following components:

40-85% cocoa solids, at the weight of between 14 and 42 Grams.

Alkalized cocoa powder at the weight of between 16 and 54 Grams.

Vegetable fat such as Cocoa butter, Palm oil and derivatives as CBS, Coconut oil, Hydrogenated rape seed oil (canola), Cocoa butter, Hydrogenated corn oil, Hydrogenated soybean oil, Hydrogenated sunflower oil, Hydrogenated safflower oil (Carthamus) at the weight of between 4 and 30 Grams

Edible oil comprising a glycerol and fatty acids wherein between 45% and 82% of the fatty acids are saturated fatty acids. Such an edible oil is added at the weight of between 10 and 60 Grams. For example, according to one aspect of the present invention the edible oil is a vegetable fat.

Emulsifying agent such as Lecithin, mono and diglycerides of fatty acids, DATEM —Diacetyl tartare acid ester of mono and diglycerides, Lactic acid ester, Polysorbate, Propylene glycol monostearate, Acetylated mono glycerides, Lactylates monoglycerides, Stearoyl Lactylates (SSL), Polyglycerol ester, Polyglycerol, polyricinoleate (PGPR), Sucrose ester of fatty acids at the weight of between 0.2 and 0.6 Grams.

Flavor enhancer agents at the weight of between 0.02 and 4.4 Grams. In some cases, such flavor enhancer agents can be flavor extracts. In some cases, the flavor base is used to add flavors to the fat-based substrate such as dark chocolate, white chocolate, vanilla, maple, caramel, dulce de leche, toffee, and the like. The flavor base composite may include the raw materials associated with the flavor, for example actual caramel or chocolate. In some other cases, the flavor base may include flavor extracts.

Fat stabilizer at the weight of between 0.4 and 3.4 Grams (For example, the crystal promoter may comprise lauric fatty acids which promotes the crystallization of the β-prime crystals).

A soluble gelatinous polysaccharide used as a stabilizing agent, at the weight of between 0.3 and 0.7 Grams. For example, hydrocolloid such as Xanthan, Xanthan gum, Tara gum, Locust bean gum, Cassia gum, Carrageenan, Guar gum, Pectin, CMC, Konjac flour can be used as the soluble gelatinous polysaccharide.

Emulsifiers at the weight of between 0.2 and 0.9 Grams. The edible composite of the subject matter comprises at least two different emulsifying agents, each of the emulsifying agents is associated with a separate product to be prepared based on the fat-based substrate of the invention. One of the emulsifying agents is mono and diglycerides of fatty acids, also known as E471, used primarily for applications of water-fat. The mono and diglycerides of fatty acids is used for baking products and provides body and stability to the cake and cookies. The mono and diglycerides of fatty acids also prevents fat blooming on confectionery products like truffles. The mono and diglycerides of fatty acids may be present in the edible composition for preparing multiple edible products in the range of 0.5%-5% by weight of the edible composition.

Another optional emulsifier in the edible composition is sucrose esters of fatty acids, also known as E473. The sucrose esters of fatty acids are used primarily as an emulsifier and stabilizer for water-fat emulsions and fat-water emulsions, depending on the HLB (Hydrophilic/Lipophilic balance). Sucrose esters with a higher HLB are usually used together with a hydrocolloid to stabilize whipped products. The sucrose esters of fatty acids may be present in the edible composition for preparing multiple edible products in the range of 0.05%-1% by weight of the edible composition.

Another optional emulsifier in the edible composition is polyglycerol esters of fatty acids also known as E475. The polyglycerol esters of fatty acids are used mainly in products with more water than oil. The polyglycerol esters of fatty acids are used for stabilizes foams, improving the aeration, increasing and stabilizing cake volume. The polyglycerol esters of fatty acids may be present in the edible composition of for preparing multiple edible products in the range of 0.1%-1% by weight of the edible composition.

Another optional emulsifier in the edible composition is Polyglycerol polyricinoleate (PGPR), also known as E 476. The Polyglycerol polyricinoleate is mainly used to liquidate and reduce viscosity of chocolate by reducing friction of non-soluble particles. The characteristics of Polyglycerol polyricinoleate improve the performance of equipment used to prepare relevant products. The Polyglycerol polyricinoleate may be present in the edible composition for preparing multiple edible products in the range of 0.05%-0.3% by weight of the edible composition.

Each of the 4 different emulsifying agents disclosed above is used in some edible products prepared from the edible composition of the subject matter, and is inert to the other edible products.

Hydrocolloid, such as Xanthan, Xanthan gum, Tara gum, Locust bean gum, Cassia gum, Carrageenan, Guar gum, Pectin, CMC, Konjac flour, at the weight of between 0.7 and 5 Grams.

Insoluble Nutritional Fiber, such as Cellulose fiber, wheat fiber, oat fiber, bamboo fiber, citrus fiber and the like at the weight of between 0.4 and 1.4 Grams.

Monosaccharide, at the weight of between 0.8 and 4 Grams.

In some embodiments of the present invention, the fat-based substrate may be provided with the required ingredients for being utilized as a fundamental material of multiple and diverse self-home-made food products, wherein the multiple and diverse food products are based on a flavor base composite, such as a vanilla-based composite, and/or a chocolate composite, such as white chocolate/dark chocolate/milk chocolate/and Vegetable fat such as cocoa butter. In such cases, the dark chocolate is replaced with white chocolate or Vegetable fat such as cocoa butter. Thus, according to one aspect of the present invention, in case the fat-based substrate is provided at the weight of essentially 70 to 200 grams, the fat-based substrate can comprise:

A flavor base such as White chocolate comprising 30% to 60% cocoa solids at the weight of between 28 and 55 Grams.

Edible oil comprising fatty acids wherein between 45% and 82% of the fatty acids are saturated fatty acids. Such an edible oil is added at the weight of between 10 and 62 Grams. For example, according to one aspect of the present invention the edible oil is a vegetable fat.

Emulsifying agent at the weight of between 2.2 and 6.7 Grams.

Flavor enhancer agents at the weight of between 0.02 to 4.6 Grams. In some cases, such flavor enhancer agents can be flavor extracts. The flavor base can add flavors to the fat-based substrate such as dark chocolate, white chocolate, vanilla, maple, caramel, dulce de leche, toffee, fruits, cinnamon, coffee, salty caramel and the like.

Fat stabilizer at the weight of between 0.4 and 3.4 Grams. For example, the fat stabilizer may comprise lauric fatty acids which promotes the crystallization of the β-prime crystals.

A soluble gelatinous polysaccharide used as a stabilizing agent, at the weight of between 0.3 and 1.2 Grams. For example, hydrocolloid such as Xanthan, Xanthan gum, Tara gum, Locust bean gum, Cassia gum, Carrageenan, Guar gum, Pectin, CMC, Konjac flour can be used as the soluble gelatinous polysaccharide.

Polysaccharide, such as Maltodextrin Sugar (Sucrose), Fructose, Corn Syrup Solids, at the weight of between 24 and 66 Grams.

Emulsifiers at the weight of between 0.1 and 0.8 Grams.

Hydrocolloid, such as Xanthan, Xanthan gum, Tara gum, Locust bean gum, Cassia gum, Carrageenan, Guar gum, Pectin, CMC, Konjac flour, at the weight of between 0.4 and 5 Grams.

Insoluble Nutritional Fiber, such as Cellulose fiber, at the weight of between 0.4 and 1.6 Grams.

Monosaccharide, such as Dextrose and/or glucose, at the weight of between 0.8 and 2.6 Grams.

In some embodiments of the present invention, the fat-based substrate is provided with a bar-shaped structure packaged in a high-barrier molds, at different weight outside the range of 70-200 Grams. Thus, the quantitative relations among the ingredients shall remain according to the quantitative relations in a substrate of 140 Grams. For example, in case the fat-based substrate is provided in a bar-shaped structure of 140 Grams, the ingredients of the fat-based substrate are about doubled of the weights mentioned for a substrate of 70 Grams. Although that in the invention disclosed herein, the weight of the bar-shaped structure can be 70 Grams, the intention of the inventor is to enable bar-shaped structures provided in diverse weights. For example, the weight of the bar-shaped structure can be any weight such as 75 Grams, 80 Grams, 90 Grams, 100 Grams, 120 Grams, 200 Grams, or any other weight. In such cases, wherein the bar-shaped structure is different than 70 Grams, the ratio of the ingredients of the bar-shaped structure remains at the same ratio as disclosed herein.

In some cases, the fat-based substrate can be wrapped with high-barrier material designed to prevent ingress of essential oils and be in physical touch with the fat-based substrate. Such a high barrier may be required to guarantee a long shelf life, wherein the exposure to vapors of essential oil is blocked.

The formulas utilized for producing the fat-based substrate combines multiple ingredients, wherein these formulas are characterized by two properties. First, these ingredients can coexist without one's chemical reactions interfering with the chemical reactions of the other. Second, different ingredients can be activated differently with different chemical reactions in different food products. Thus, in one exemplary embodiment of the disclosed invention, the fat-based substrate can comprise the following ingredients: a flavor base such as a chocolate composite, Vegetable fat such as Cocoa butter, Mono-diglyceride, Polyglycerol ester, Chocolate flavor enhancers, Caramel flavor enhancers, Vanilla flavor enhancers, Fat stabilizer, hydrocolloid such as Xanthan, Xanthan gum, Tara gum, Locust bean gum, Cassia gum, Carrageenan, Guar gum, Pectin, CMC, Konjac flour, Emulsifiers, such as Sucrose ester, In such an exemplary embodiment, the fat-based substrate can be used for preparing ganache, wherein the mono-diglyceride and polyglycerol ester of the fat-based substrate are inert in the process of preparing the ganache and thereby do not interfere to the other ingredients during the ganache preparing process. On the other hand, the same fat-based substrate with the same ingredient list can be used for preparing chocolate muffins, wherein the hydrocolloid such as Xanthan, Xanthan gum, Tara gum, Locust bean gum, Cassia gum, Carrageenan, Guar gum, Pectin, CMC, Konjac flour and emulsifiers, such as sucrose ester of the fat-based substrate are inert in the process of preparing the chocolate muffins and thereby do not interfere to the other ingredients during the preparing process of the chocolate muffins.

It is an object of the subject matter to disclose an edible composition for preparing multiple edible products, said composition comprising a flavor base, a fat stabilizer, hydrocolloids, edible oil comprising fatty acids and at least two emulsifying agents selected from a group comprising (a) a mixture of diglycerides and monoglycerides of fatty acids, (b) Sucrose esters of fatty acids, (c) Polyglycerol esters of fatty acids (d) Polyglycerol polyricinoleate.

In some cases, the composition further comprises Alkalized cocoa powder. In some cases, the composition further comprises a vegetable fat. In some cases, the composition further comprises hydrocolloids. In some cases, the composition comprising at least three emulsifying agents selected from a group comprising (a) a mixture of diglycerides and monoglycerides of fatty acids, (b) Sucrose esters of fatty acids, (c) Polyglycerol esters of fatty acids (d) Polyglycerol polyricinoleate.

In some cases, the flavor base is selected from dark Chocolate, milk chocolate, white chocolate, vanilla composite, chocolate coverture, carob chocolate substitute, Maple, Caramel, Dulce de leche, Toffee, Tahina, Nuts, Lemon, Red velvet, salted caramel, lemon, orange, almonds, strawberry and a combination thereof. In some cases, the fat stabilizer comprises a crystal promoter. In some cases, the fat stabilizer comprises lauric fatty acids. In some cases, the edible oil comprises a vegetable fat. In some cases, the vegetable fat comprises saturated fatty acids. In some cases, the edible oil comprises glycerol and fatty acids. In some cases, the saturated fatty acid has a melting point of a pure compound of at least 40 degrees Celsius. In some cases, the edible oil compounds may comprise a lauric fatty acid.

In some cases, the mixture of diglycerides and monoglycerides of fatty acids is present in the edible composition in the range of 0.5%-5% by weight of the edible composition. In some cases, the Sucrose esters of fatty acids is present in the edible composition in the range of 0.05%-1% by weight of the edible composition.

In some cases, the Polyglycerol esters of fatty acids is present in the edible composition in the range of 0.1%-1% by weight of the edible composition. In some cases, the Polyglycerol polyricinoleate is present in the edible composition in the range of 0.05%-0.3% by weight of the edible composition. In some cases, the edible oil is present in the edible composition in the range of 45%-82% by weight of the edible composition. In some cases, the fat stabilizer is present in the edible composition in the range of 0.2%-5% by weight of the edible composition. In some cases, the flavor base is present in the edible composition in the range of 0.01%-1% by weight of the edible composition.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A discloses a process of preparing a mixture of edible oil characterized by saturated fatty acids and chocolate, according to exemplary embodiments of the present invention;

FIG. 1B discloses a process of preparing a mixture of edible oil characterized by saturated fatty acids and vegetable fat, according to exemplary embodiments of the present invention;

FIG. 2 discloses a process of converting a mixture of edible oil characterized by saturated fatty acids and chocolate to a stabilized chocolate substrate for preparing multiple and diverse self-home-made food products, according to exemplary embodiments of the present invention;

FIG. 3 shows the process of making the fat-based substrate from a mixture, according to exemplary embodiment of FIG. 2;

FIG. 4 shows two mixer systems utilized to prepare the fat-based substrate, according to some embodiments of the present invention;

FIG. 5 shows a system designed to produce a fat-based mixture and convert the fat-based mixture to a fat-based substrate, according some embodiments of the present invention, and;

FIG. 6 shows a list of possible activated ingredients according to the diverse self-home-made food products, which can be prepared thereof, in accordance with exemplary embodiments of the present invention.

### DETAILED DESCRIPTION OF THE INVENTION

The present invention discloses a method to manufacture a fat-based substrate which can be utilized as a fundamental material for preparing multiple and diverse self-home-made food products. The fat-based raw material can contain a relatively high rate of fatty ingredients and chocolates. Such a high a relatively high rate of fatty ingredients is at least 45% of fatty ingredients in the total fat-based substrate. A portion of the fat-based substrate is characterized by fatty ingredients having a melting point which is higher than 40 degrees Celsius. Such high melting point contributes to the stability of the fat-based substrate and the shelf life thereof. The term “shelf life” used herein is the length of time that the fat-based substrate disclosed herein is stored without becoming unfit for use or consumption. In some cases, a fat-based substrate can become unfit for use by losing the characteristics, and/or values and/or taste thereof.

The method disclosed herein is designed to achieve high percentage of fat crystals in β-type form. These β-type crystals improve the homogeneity of the texture in the fat-based substrate. The method disclosed herein is also designed to allow packaging of the fat-based substrate in a process characterized by relatively low temperature. Such a low temperature is maintained to minimize the attraction of the fat-based substrate to essential oils. The attraction to essential oils is characterized in cases wherein a substrate containing high fat rates is exposed to vapors of essential oil.

The method disclosed herein is also designed to provide the required packaging solution, to enable a shelf life of 12 to 24 months. The fat-bases substrate of the present invention may be stored in a wide range of conditions, from standard cooling conditions (4-12 degrees Celsius) to frozen conditions, for example in minus 18 degrees Celsius. In case the fat-bases substrate is kept in cooling conditions, the fat-bases substrate may include Preservatives, such as Potassium sorbate, Sodium benzoate and Propionic acid. In some other cases, the fat-bases substrate is kept on a non-cooled shelf. The fat-based substrate may also include Antioxidants, such as Tocopherol, Rosemary extract, Anthocyanins, Vitamin C, sodium ascorbate, calcium ascorbate, Grape seed extract, Tea extract, TBHQ, BHA, BHT and Oregano oil. The fat-based substrate, produced by processes implementing the methods disclosed herein, can be utilized in the frozen or chilled or shelf stable thereof, for preparing multiple and diverse self-home-made food products. The fat-based substrate can also undergo an unfreezing melting process and then be mixed with additional ingredients, according to the target self-home-made food products being prepared. For example, the fat-based substrate can undergo a melting process and then be placed in a bowl and mixed with eggs, flour, water and Polysaccharide such as sugar. Then, the mixture can be placed in a baking mold and be baked for 30 minutes. In this exemplary case, the fat-based substrate may be a cake, enriched with chocolate and fats.

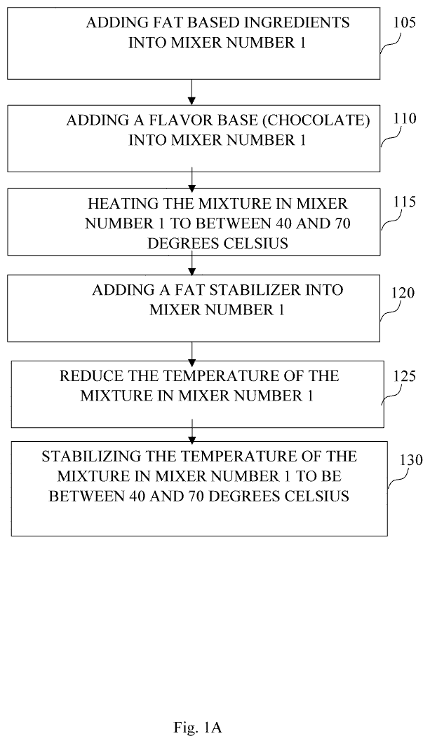

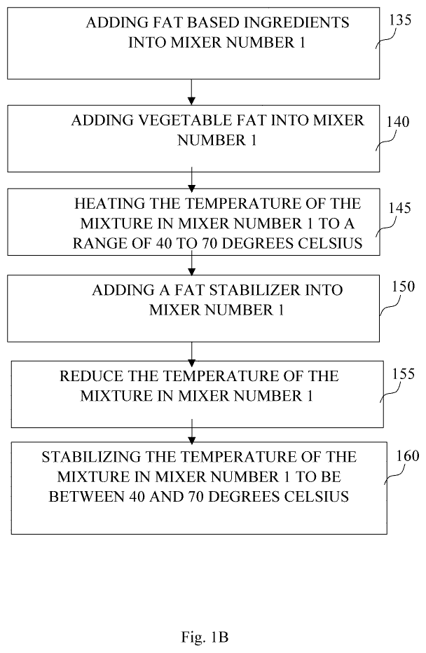

FIG. 1A discloses a process of preparing a mixture of edible oil characterized by saturated fatty acids and chocolate, according to exemplary embodiments of the present invention. Step 105 defines a process of adding fat based ingredients into a mixer denoted as a mixer number 1. In some cases, the process of adding the fat-based ingredients may be performed by a person. In some other cases, such a process of adding fat-based ingredients to mixer number 1 may be a mechanically process conducted by a machine. The fat-based ingredients added to mixer number 1 may comprise edible oil compounds comprising saturated fatty acids. In some embodiments of the present invention the edible oil compounds incorporated in the mixture at mixer number 1 may comprise a glycerol and fatty acids characterized by between 45% and 82% of saturated fatty acids. In some cases, the saturated fatty acids may be monounsaturated fatty acids. In some embodiments of the present invention, the added edible oil may be vegetable fat such as cocoa butter and/or vegetable fat such as coconut oil. In one aspect of the present invention, the edible oil compounds may comprise a saturated fatty acid with a melting point of the pure compound of at least 40 degrees Celsius. For example, when the edible oil compounds may comprise a lauric fatty acid.

Step 110 describes the phase of adding a flavor base such as chocolate to the mixture in mixer number 1. At step 115 the mixture's temperature is raised to be between 40 and 70 degrees Celsius. In some cases, the process of raising the temperature may be performed by a person. In some other cases, such a process of raising the temperature in the mixture at mixer number 1 may be a mechanically process conducted by a machine. For example, mixer number 1 may be a jacketed vessel designed to control the temperature of the content thereof. Such a control may be by using a cooling or heating jacket around the vessel through which a cooling or heating fluid is circulated. In such case the circulation of the fluid can be controlled by a dedicated machine configured to maintain the mixture within the vessel in a fixed level.

At step 120 the Fat stabilizer is added to the mixture at mixer number 1. The intention of the inventor herein is to allow a crystalline state of β-prime type which is also known as relatively small crystal size. At step 125 the heating of the mixture is reduced. At step 130 the temperature of the mixture in mixer number 1 is stabilized to be between 40 and 70 degrees Celsius. FIG. 1B discloses a process of preparing a mixture of edible oil characterized by saturated fatty acids and vegetable fat, according to exemplary embodiments of the present invention. Step 135 defines a process of adding fat based ingredients into a mixer denoted as a mixer number 1. In some cases, the process of adding the fat-based ingredients may be performed by a person. In some other cases, such a process of adding fat-based ingredients to mixer number 1 may be a mechanically process conducted by a machine. The fat-based ingredients added to mixer number 1 may comprise edible oil compounds comprising saturated fatty acids. In some embodiments of the present invention the edible oil compounds incorporated in the mixture at mixer number 1 may comprise a glycerol and fatty acids characterized by between 45% and 82% of saturated fatty acids. In some cases, the saturated fatty acids may be monounsaturated fatty acids. In some embodiments of the present invention, the added edible oil may be vegetable fat such as cocoa butter and/or vegetable fat such as coconut oil. In one aspect of the present invention, the edible oil compounds may comprise a saturated fatty acid with a melting point of the pure compound of at least 40 degrees Celsius. For example, when the edible oil compounds may comprise a lauric fatty acid.

Step 140 describes the phase of adding vegetable fat to the mixture in mixer number 1. At step 145 the mixture's temperature is raised to be between 40 and 70 degrees Celsius. In some cases, the process of raising the temperature may be performed by a person. In some other cases, such a process of raising the temperature in the mixture at mixer number 1 may be a mechanically process conducted by a machine. For example, mixer number 1 may be a jacketed vessel designed to control the temperature of the content thereof. Such a control may be by using a cooling or heating jacket around the vessel through which a cooling or heating fluid is circulated. In such case the circulation of the fluid can be controlled by a dedicated machine configured to maintain the mixture within the vessel in a fixed level.

At step 150 the Fat stabilizer is added to the mixture at mixer number 1. The intention of the inventor herein is to allow a crystalline state of β-prime type which is also known as relatively small crystal size. At step 155 the heating of the mixture is reduced. At step 160 the temperature of the mixture in mixer number 1 is stabilized to be between 40 and 70 degrees Celsius.

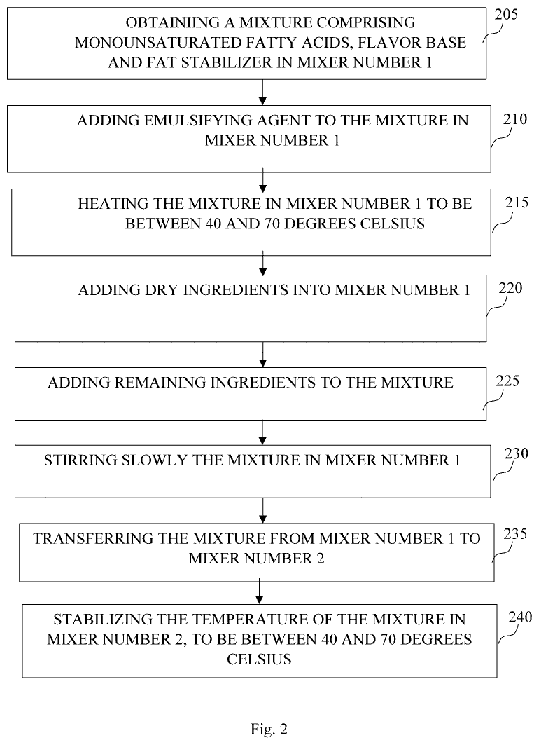

FIG. 2 discloses a process of converting a mixture of edible oil characterized by saturated fatty acids and chocolate to a stabilized chocolate substrate for preparing multiple and diverse self-home-made food products, according to exemplary embodiments of the present invention. At step 205 a mixture comprising monounsaturated fatty acids, chocolate and fat stabilizer is obtained in mixer number 1. The chocolate is an example of a base. At step 210 an emulsifying agent is added to mixer number 1. At step 215 the mixture temperature in mixer number 1 is raised up to be between 40 and 70 degrees Celsius. At step 220 the dry ingredients are added to the mixture in mixer number 1. In one aspect of the present invention, food additives such as Polysaccharide, such as a Maltodextrin, hydrocolloid such as Xanthan, Xanthan gum, Tara gum, Locust bean gum, Cassia gum, Carrageenan, Guar gum, Pectin, CMC, Konjac flour may be added to the mixture in mixer number 1. At step 225 additional ingredients are added to said mixture. Such ingredients can comprise flavor extracts and food coloring. In one aspect of the present invention the food coloring ingredients are oil-soluble food colorings. At step 230 the mixture may be stirred slowly. Such slow stirring may be performed at 6 to 60 RPM (round per minute) until a homogeneous mixture is obtained.

At step 235 the mixture in mixer number 1 is transferred into the mixer number 2. At step 240 the temperature of the mixture in mixer number 2 may be stabilized to be between 40 and 70 degrees Celsius. In some cases, and additional stirring time may be required. In such cases, the additional stirring taking place at step 240 prevents from the mixture to crystallize. At the end of step 240 a homogenized mixture is obtained. The obtained mixture may also be rich in high levels of monounsaturated fatty acids and flavor base such as chocolate, wherein at least a portion of the monounsaturated fatty acids is characterized by a melting point of at least 40 degrees Celsius measured at the pure compound of the monounsaturated fatty acids.

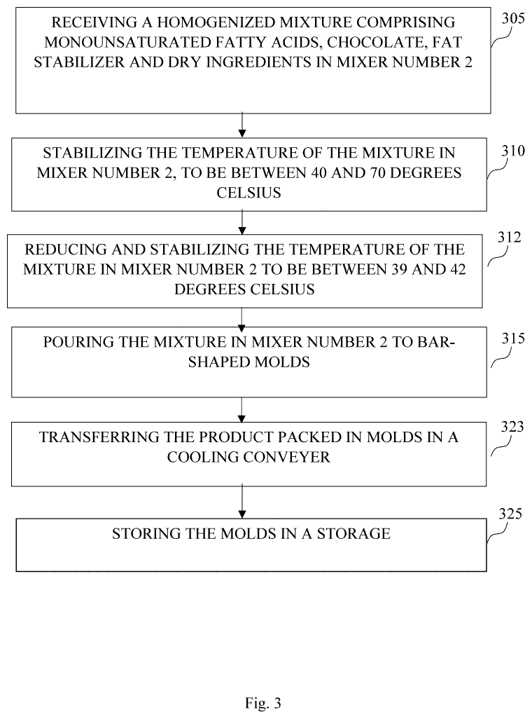

FIG. 3 shows the process of making the fat-based substrate from a mixture, according to exemplary embodiment of FIG. 2. At step 305 a homogenized mixture is obtained in mixer number 2. The obtained mixture can also be rich in high levels of monounsaturated fatty acids and flavor base such as chocolate, wherein at least a portion of the monounsaturated fatty acids is characterized by a melting point of at least 40 degrees Celsius measured at the pure compound of the monounsaturated fatty acids. At step 310 the temperature of the mixture in mixer number 2 is stabilized at between 40 and 70 degrees Celsius. At step 312 the mixture temperature in mixer number 2 is reduced and stabilized to be between 39 and 42 degrees Celsius. In such cases, the mixture is also stirred and mixed at mixer number 2.

At step 315 the mixture is poured into a bar-shaped molds, wherein the bar-shaped mold comprises layers of high-barrier material. In such cases, the high-barrier material may prevent from essential oils to be attracted to the mixture resting in the bar-shaped molds. Such essential oils can be volatile oils, ethereal oils, or other oils containing volatile aroma compounds from plants.

The-bar-shaped molds are designed to provide with the fat-based substrate in fixed and predefined bar-shaped portions, wherein each bar-shaped portion is one fixed portion. Such a fixed portion can be between 70 and 200 Grams. In such cases, a bar-shaped portion can be utilized for making a specific food product, according to a predefined recipe. In some cases, the mixture in the bar-shaped molds can be utilized in diverse recipes for preparing multiple types of food products. The amount of monounsaturated fatty acids and flavor base such as chocolate which are packed in package of between 70 and 200 grams can facilitate simple, easy and fast processes of preparing multiple food products not clear. In some embodiments of the present invention the fixed portion in the bar-shaped mold can be between 70 and 200 Grams.

Step 323 discloses transferring the product packed in molds in a cooling conveyer. The length of the cooling conveyer may be in the range of 2.0-30.0 meters. The temperature in the cooling conveyer may be in the range of 9 to 26 degrees Celsius. The product is transferred in the cooling conveyer for a duration in the range of 60-1800 seconds. The cooling conveyer enables to stabilize the product and assists in the crystallization process.

At step 325 the molds containing the mixture are stored in a storage. The storage may be stored the mixture in the molds in the range of minus 4 to minus 18 degrees Celsius. In some other cases, the molds containing the mixture are stored in dry storage conditions, for example in a temperature range of 6-25 degrees Celsius.

In some embodiments of the present invention the bar-shaped mold may be replaced with a rectangle shaped mold. In possible embodiments of the present invention the bar-shaped mold may be replaced with a round-shaped mold.

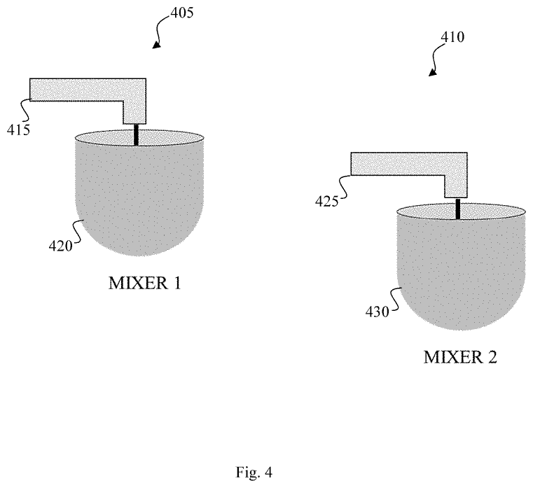

FIG. 4 shows two mixer systems utilized to prepare the fat-based substrate, according to some embodiments of the present invention. FIG. 4 shows a mixer 405 denoted as mixer number 1. Mixer 405 comprises an arm 415 of the mixer 405. The arm 405 is used to insert the blades of the mixer (not shown) to the pot 420 of the mixer. In some cases, the instructions of the method disclosed herein, and which comprise steps such as inserting ingredients to mixer number 1, the intention of the inventor is inserting ingredients to a mixer such as pot 420. In some cases, pot 420 may be a double jacketed tanks (barrels) or any other heating containers which is a pot designed to control temperature of the contents thereof, by using a cooling or heating jacket around the pot 420 through which a cooling or heating fluid is circulated.

FIG. 4 also shows a mixer 410 denoted as mixer number 2. Mixer 410 comprises an arm 425 of the mixer 410. The arm 425 is used to insert the blades of the mixer (not shown) to the pot 430 of the mixer. In some cases, the instructions of the method disclosed herein, and which are comprising steps such as insert ingredients to mixer number 2, the intention of the inventor in these cases, is to insert the ingredients to the pot 430. In some cases, pot 430 may be a jacketed pot which is a pot designed to control the temperature of its contents, by using a cooling or heating jacket around the pot 430 through which a cooling or heating fluid is circulated.

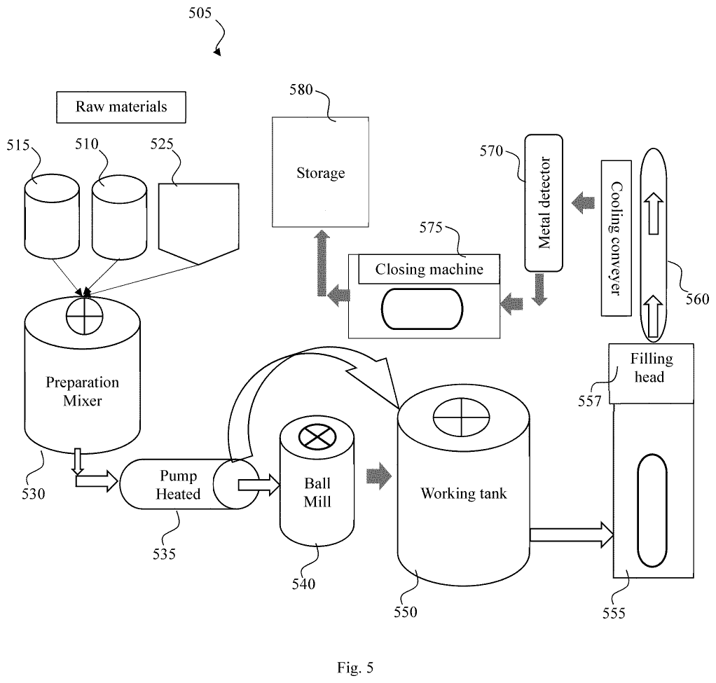

FIG. 5 shows a system designed to produce a fat-based mixture and convert the fat-based mixture to a fat-based substrate, according to exemplary embodiments of the subject matter. FIG. 5 shows a fat-based substrate producing system 505 for implementing the methods for producing the fat-based substrate as aforementioned. System 505 comprises mixers 515 and 510 designed for facilitating the process of preparing the fat-based ingredients, such as described at steps 210, 110 and 220 above. In some cases, raw materials containers 515 and 510 designed to control the temperature of the content thereof, by using a cooling or heating jacket around the mixers 515 and 510 through which a cooling or heating fluid is circulated. System 505 also comprises, a container 525 designed to contain dry ingredients such as described at steps 120 and 225. For example, container 525 can contain ingredients such as Polysaccharide, hydrocolloid, Hydrocolloid, and the like. System 505 also comprises, a preparation mixer 530 designed to receive the ingredients from containers 515, 510, and 525, mix the received ingredients to form a fat-based mixture which can be the raw material for the fat-based substrate such as described at steps 105, 115, 125, 130 and 205, 215 and 230 above. The preparation mixer 530 is also designed to control the temperature of content thereof. In some cases, the content may be such as fatty acids, mixed with flavor base such as chocolate and dry ingredients as aforementioned. In some cases, the containers 515 and 510, and 525 are configured with the mechanism to pour the content thereof to the preparation mixer 530 such as described at step 235 above. The preparation mixer 530 is designed to mix and control the temperature of the mixture formed by the ingredients poured from the containers 515 and 510, and 525. Such a temperature may be between 40 and 70 degrees Celsius. The weight of the mixture within the preparation mixer 530 and the temperature thereof are designed to prevent solidification of the mixture, and/or separation of the fat ingrediency within the mixture.

The system 505 also comprises a heated pump 535 which can be optionally configured to transfer mixture through a ball mill 540 to a working tank 550 such as described for example at steps 235 and 323 above. The ball mill 540 is designed to reduce the fat particle size by grinding the fat particles from 60 microns to 25 microns. In such cases wherein the ball mill 540 is used, the fat particles can be grinded to smooth sensation of the final food product in the mouth. The system 505 also comprises a working tank 550 designed to contain 2-3 loads of preparation mixer 530 and control the temperature of the mixture. Working tank 550 may also be designed to heat up the mixture and maintain the mixture in a certain level of temperature, for example in the range of 40 and 70 degrees Celsius, measured for 250 liters of a mixture. The weight of the mixture within the working tank 550 and the temperature thereof are designed to prevent solidification of the mixture, and/or separation of the fat ingrediency within the mixture.

System 505 also comprises a conveyor system 555 designed to receive the mixture being mixed in the working tank 550, at a temperature of between 40 and 70 degrees Celsius and convey this mixture forward toward the filling head 557 such as described at step 323 above. The filling head 557 can be configured to pour the mixture conveyed by the conveyor system 555 to bar-shaped molds (not shown). In some cases, the mixture is provided in a bar-shaped structure packaged at a high-barrier molds, at the weight in the range of 70-200 grams. In some cases, the mixture is provided in a bar-shaped structure packaged at a high-barrier molds.

The bar-shaped molds may be placed on the cooling conveyor 560. In some cases, the cooling conveyor 560 may be configured to vibrate the bar-shaped molds with the mixture within, till a homogenized mixture is obtained such as described at step 320 above. Such a vibration can prevent from air bubbles to form within the poured mixture. The conveyer is also designed to convey the mixture-filled molds in a temperature of between 9 and 26 degrees Celsius, to allow a crystalline state of β-prime type which is also known as relatively small crystal size. In some cases, the ratio of the β-prime type can be reached to between 1% and 1.5% of all crystalline types.

In some embodiments of the present invention, the filling head 557 may be configured with a filling power of up to 150-200 kilograms of mixture per one hour. Such a filling power may allow a continuous filling process without a necessity to halt the production process of system 505. The continuous filling process may allow maintaining the mixture in desirable temperature levels. For example, the temperature in preparation mixer 530 can be maintained at the level of between 40 and 70 degrees Celsius, and the temperature in the working tank 550 can be maintained at the level of between 40 and 70 degrees Celsius. Maintaining the temperature at specific levels according to the process requirement, without cooling the mixture down can prevent solidification of the mixture. Forming of solids and cooled fatty ingredients may create a need to involve water in the cleaning process.

The system 505 also comprises a metal detector 570 for detecting metallic residues on the mixture. The filled molds may also undergo a closing process at the closing machine 575, wherein a lid is placed on the mold and cover the mixture within. Such a lid may be formed of a paper, carton, BOPP, PE, Aluminum, and the like. In some cases, additional packaging processes may take place to seal and close the mixture within the molds. In some cases, the lid may be welded to the mold. After the closing machine 575 the filled molds may continue to the storage 580. Such storage 580 may be configured to maintain the mixture in the molds in a temperature range of minus 15 to minus 25 degrees Celsius. In some other cases, the mixture may be stored in a chilled state, for example in the range of 0-4 degrees Celsius. The mixture may be stored in a dry state, for example in the range of 6-18 degrees Celsius Such a final step may be required for utilizing the mixture as a fat-based substrate for multiple food products. It should be noted that freezing the mixture is optional only. The mixture may be marketed and transferred in a refrigerator having a temperature in the range of 2-15 degrees Celsius. The mixture may also comprise antioxidants and preservatives as known in the art.

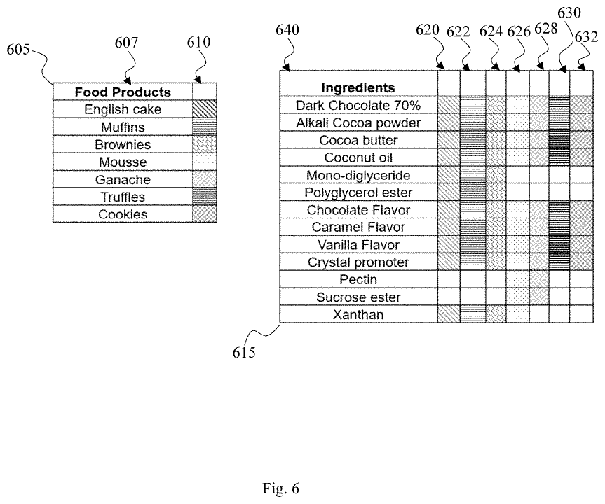

FIG. 6 shows a list of possible activated ingredients according to the diverse self-home-made food products, which can be prepared thereof, in accordance with exemplary embodiments of the present invention. FIG. 6 shows a table 605 with optional food products. Table 605 contains a column 607 with possible self-home-made food products which can be prepared out a fat-based substrate as disclosed by the present invention. Table 605 also contains a column 610 which comprises patterns representing the food products in column 607. FIG. 6 also comprises a table 610 comprising a list of possible activated ingredients. Table 610 contains a column 640 which comprises the ingredients of a formula utilized for producing a certain fat-based substrate, wherein this formula is characterized by two properties. First, these ingredients can coexist without one's chemical reactions interfering with the chemical reactions of the other. Second, different ingredients can be activated differently with different chemical reactions in different self-home-made food products.

Table 610 presents the activated ingredients in case of preparing an English Cake, at column 620. In such case, the activated ingredients are: flavor base such as chocolate composite such as Dark Chocolate, 40% up to 85%, Milk Chocolate, White Chocolate, Chocolate Coverture (Dark, Milk or white), Carob Chocolate substitute and a combination thereof. The activated ingredients also include Alkali cocoa powder, vegetable fat such as Cocoa butter, Mono-diglyceride, Polyglycerol ester, Chocolate flavor enhancers, Caramel flavor enhancers, Vanilla flavor enhancers, fat stabilizer, and Hydrocolloid. In such a case the ingredients hydrocolloid and emulsifiers, such as Sucrose ester exist in the fat-based substrate but inert in the process of making the food product English Cake.

Table 610 also presents the activated ingredients in case of preparing muffins, at column 622. In such case, the activated ingredients are: flavor base such as chocolate composite such as Dark Chocolate, Alkali cocoa powder, Vegetable fat such as Cocoa butter, Mono-diglyceride, Polyglycerol ester, Chocolate flavor enhancers, Caramel flavor enhancers, Vanilla flavor enhancers, fat stabilizer, and Hydrocolloid. In such a case the ingredients hydrocolloid and emulsifiers, such as Sucrose ester exist in the fat-based substrate but inert in the process of making the food product muffins.

Table 610 also presents the activated ingredients in case of preparing Brownies, at column 624. In such case, the activated ingredients are: flavor base such as chocolate composite such as Dark Chocolate, Alkali cocoa powder, Vegetable fat such as Cocoa butter, Mono-diglyceride, Polyglycerol ester, Chocolate flavor enhancers, Caramel flavor enhancers, Vanilla flavor enhancers, fat stabilizer, and Hydrocolloid. In such a case the ingredients Pectin and Emulsifiers, such as Sucrose ester exist in the fat-based substrate but inert in the process of making the food product Brownies.

Table 610 also presents the activated ingredients in case of preparing mousse, at column 626. In such case, the activated ingredients are: flavor base such as chocolate composite such as Dark Chocolate, Alkali cocoa powder, Vegetable fat, Chocolate flavor enhancers, Caramel flavor enhancers, Vanilla flavor enhancers, fat stabilizer, hydrocolloid, Emulsifiers, such as Sucrose ester and Hydrocolloid, such as Xanthan. In such a case the ingredients Mono-diglyceride and Polyglycerol exist in the fat-based substrate but inert in the process of making the food product mousse.

Table 610 also presents the activated ingredients in case of preparing ganache, at column 628. In such case, the activated ingredients are: flavor base such as chocolate composite such as Dark Chocolate, Alkali cocoa powder, Vegetable fat, Chocolate flavor enhancers, Caramel flavor enhancers, Vanilla flavor enhancers, fat stabilizer, Pectin, and Emulsifiers, such as Sucrose ester. In such a case the ingredients Mono-diglyceride, Hydrocolloid, and Polyglycerol exist in the fat-based substrate but inert in the process of making the food product ganache.

Table 610 also presents the activated ingredients in case of preparing ganache, at column 630. In such case, the activated ingredients are: flavor base such as chocolate composite such as Dark Chocolate, Alkali cocoa powder, Vegetable fat, Chocolate flavor enhancers, Caramel flavor enhancers, Vanilla flavor enhancers, and fat stabilizer. In such a case the ingredients Mono-diglyceride, Hydrocolloid, hydrocolloid, Emulsifiers, such as Sucrose ester and Polyglycerol exist in the fat-based substrate but inert in the process of making the food product ganache.

Table 610 also presents the activated ingredients in case of preparing cookies, at column 632. In such case, the activated ingredients are: flavor base such as chocolate composite, Alkali cocoa powder, Cocoa butter, Chocolate flavor enhancers, Caramel flavor enhancers, Vanilla flavor enhancers, and fat stabilizer. In such a case the ingredients Mono-diglyceride, Hydrocolloid, another hydrocolloid, Emulsifiers, such as Sucrose ester and

Polyglycerol exist in the fat-based substrate but inert in the process of making the food product cookies.

### EXAMPLES

### Example 1

A self-home-made chocolate cake can be prepared out of one bar-shaped portion and an addendum of the following ingredients:

200 grams of Polysaccharide

2 eggs

150 grams water

140 grams of flour+Sodium bicarbonate

The chocolate cake can be prepared by melting the bar-shaped portion to be melted portion, mixing the melted portion with the Polysaccharide, adding the eggs, the water, the flour and the Sodium bicarbonate to the mixture. Inserting the mixture to a baking dish and bake the cake in 180 degrees Celsius for 30 minutes.

This recipe shall convert the fat-based substrate to a cake, wherein the high fat levels and the chocolate contributes to the moisture feeling and the flavors of chocolate cake.

### Example 2

Minor changes of the example given in Example 1 can be utilized for preparing self-home-made rich chocolate cake, also known as brownie cookies. The brownie cookies can be prepared out of two bar-shaped portions and an addendum of the following ingredients:

300 grams of Polysaccharide

2 eggs

140 grams of flour+Sodium bicarbonate

The chocolate cake can be prepared by melting the bar-shaped substrate, melting the two bar-shaped portions to be melted portions, mixing the melted portions with the Polysaccharide, adding the eggs, and the flour and the Sodium bicarbonate to the mixture. Inserting the mixture to a baking dish and bake the brownie cookies in 165 degrees Celsius for 25 minutes.

This recipe shall convert the fat-based substrate to brownie cookies, wherein the high fat levels and the chocolate contributes the moisture feeling, and the flavors of chocolate brownie cookies.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. An edible composition for preparing multiple edible products, said composition comprising:
a flavor base;
hydrocolloids;
edible oil comprising fatty acids;
at least two emulsifying agents selected from a group comprising (a) a mixture of diglycerides and monoglycerides of fatty acids, (b) Sucrose esters of fatty acids, (c) Polyglycerol esters of fatty acids (d) Polyglycerol polyricinoleate.

2. The composition of claim 1, further comprises Alkalized cocoa powder.

3. The composition of claim 1, further comprises a vegetable fat.

4. The composition of claim 1, wherein comprising at least three emulsifying agents selected from a group comprising (a) a mixture of diglycerides and monoglycerides of fatty acids, (b) Sucrose esters of fatty acids, (c) Polyglycerol esters of fatty acids (d) Polyglycerol polyricinoleate.

5. The composition of claim 1, wherein the flavor base is selected from dark Chocolate, milk chocolate, white chocolate, vanilla composite, chocolate coverture, carob chocolate substitute, Maple, Caramel, Dulce de leche, Toffee, Tahina, Nuts, Lemon, Red velvet, salted caramel, lemon, orange, almonds, strawberry and a combination thereof.

6. The composition of claim 1, further comprising a fat stabilizer.

7. The composition of claim 6, wherein the fat stabilizer comprises a crystal promoter.

8. The composition of claim 6, wherein the fat stabilizer comprises lauric fatty acids.

9. The composition of claim 1, wherein the edible oil comprises a vegetable fat.

10. The composition of claim 9, wherein the vegetable fat comprises saturated fatty acids.

11. The composition of claim 1, wherein the edible oil comprises glycerol and fatty acids.

12. The composition of claim 10, wherein the saturated fatty acid has a melting point of a pure compound of at least 40 degrees Celsius.

13. The composition of claim 1, wherein the edible oil compounds may comprise a lauric fatty acid.

14. The composition of claim 1, wherein the mixture of diglycerides and monoglycerides of fatty acids is present in the edible composition in the range of 0.5%-5% by weight of the edible composition.

15. The composition of claim 1, wherein the Sucrose esters of fatty acids is present in the edible composition in the range of 0.05%-1% by weight of the edible composition.

16. The composition of claim 1, wherein the Polyglycerol esters of fatty acids is present in the edible composition in the range of 0.1%-1% by weight of the edible composition.

17. The composition of claim 1, wherein the Polyglycerol polyricinoleate is present in the edible composition in the range of 0.05%-0.3% by weight of the edible composition.

18. The composition of claim 1, wherein the edible oil is present in the edible composition in the range of 5%-88% by weight of the edible composition.

19. The composition of claim 1, wherein the fat stabilizer is present in the edible composition in the range of 0.2%-5% by weight of the edible composition.

20. The composition of claim 1, wherein the flavor base is present in the edible composition in the range of 0.01%-1% by weight of the edible composition.
